(19) United States
(12) Patent Application Publication
(10) Pub. No.: US 2025/0235807 A1
(43) Pub. Date: Jul. 24, 2025

(54) APPARATUSES FOR RETAINING FILTER ELEMENTS IN FILTER HOLDER FRAMES

(71) Applicant: L & D Distributors Ltd., Edmonton (CA)

(72) Inventors: Mike BENOIT, Edmonton (CA); Darcy NYSTROM, Edmonton (CA)

(73) Assignee: L & D Distributors Ltd., Edmonton (CA)

(21) Appl. No.: 19/030,378

(22) Filed: Jan. 17, 2025

Related U.S. Application Data
(60) Provisional application No. 63/623,162, filed on Jan. 19, 2024.

(51) Int. Cl. B01D 46/00

(52) U.S. Cl. CPC B01D 46/0005; B01D 2265/023; B01D 2265/028; B01D 2279/50

(57) ABSTRACT

An apparatus for retaining a filter element in a filter holder frame in a HVAC system is provided where the apparatus is a retainer clip that is inserted between the filter element in the filter holder frame and magnetically held in place by a magnet on the retainer clip. A grip/stop on the retainer clip holds the filter element against a filter seating surface on the filter holder frame.

### CROSS-REFERENCE TO RELATED APPLICATIONS

This application claims priority of U.S. Provisional Patent Application Ser. No. 63/623,162 filed Jan. 19, 2024, which is incorporated by reference into this application in its entirety.

### TECHNICAL FIELD

The present disclosure is related to the field of apparatuses for retaining filter media in heating, ventilation, and air conditioning (“HVAC”) systems in filter holding frames, in particular, filter retainer clips that magnetically attach to the filter holding frames.

### BACKGROUND

In HVAC systems, filter media is used to remove impurities from atmospheric air before being drawn into the HVAC system. Replaceable filters are often used as the filter media that can be installed and removed from a filter frame. Referring to FIGS. 1 and 2, a prior art filter retainer mechanism is shown. In FIG. 1, prior art knock-on latch A is shown clipped onto universal filter holder frame B, which are typically made of ferrous metals. FIG. 2 shows pleated filter element C seated in filter holder frame B with knock-on latch A rotated a quarter turn so that the loop handle thereof acts as a retainer to keep pleated filter element C from being removed from filter holder frame B.

The problem with the use of knock-on latches is that they sit between filter holder frame B and filter C wherein clip F of latch A deflects filter C away from seating surface G of filter holder frame B by the thickness of clip F. This deflection prevents filter C from fully seating onto filter seating surface G of filter holder frame B thereby allowing unfiltered atmospheric air to flow through the space between filter C and filter holder frame B caused by the deflection, which can defeat the purpose of the filter mechanism.

It is, therefore, desirable to provide an apparatus that overcomes the shortcomings of the prior art and can retain a filter onto a seating surface of a filter holder frame B.

### SUMMARY

In some embodiments, a filter retainer clip can be provided that can hold a filter media element within a filter holding frame where the filter retainer magnetically attaches to the filter holding frame.

Broadly stated, in some embodiments, an apparatus can be provided for retaining a filter element in a filter holder frame, the apparatus comprising: a base comprising a top surface and a bottom surface; a grip/stop disposed substantially orthogonal on a top surface of the base forming a first leg on one side of the grip/stop and forming a second leg on another side of the grip/stop; and a magnet disposed on the top surface or on the bottom surface.

Broadly stated, in some embodiments, the first leg can be longer than the second leg.

Broadly stated, in some embodiments, the bottom surface can comprise a recess for receiving the magnet.

Broadly stated, in some embodiments, the top surface can comprise a recess for receiving the magnet.

Broadly stated, in some embodiments, the apparatus can comprise adhesive for holding the magnet in the recess.

Broadly stated, in some embodiments, the combination of the magnet and the bottom surface can form a uniformly flat surface.

Broadly stated, in some embodiments, the apparatus can be comprised of high-density plastic.

Broadly stated, in some embodiments, the apparatus can be comprised of non-ferrous metal.

Broadly stated, in some embodiments, the apparatus can further comprise a channel disposed at least partially about a circumference of the recess.

Broadly stated, in some embodiments, the apparatus can further comprise a top plate for sandwiching the magnet between the top plate and the base, wherein the top plate can comprise at least one catch having a hook thereon, and wherein the hook can be configured for inserting into the channel to attach the top plate to the base.

Broadly stated, in some embodiments, the top plate can comprise a second recess for receiving the magnet.

### BRIEF DESCRIPTION OF THE DRAWINGS

FIG. 1 is a perspective view depicting a prior art knock-on latch for retaining pleated filters in a filter holding frame.

FIG. 2 is a perspective view depicting the prior art knock-on latch of FIG. 1 retaining the pleated filter in the filter holding frame.

FIG. 3 is an upper perspective view depicting one embodiment of a filter retaining clip for retaining a filter element in a filter holding frame.

FIG. 4 is a lower perspective view depicting the filter retainer clip of FIG. 3.

FIG. 5 is a diagram depicting multiple views of the filter retainer clip of FIG. 3.

FIG. 6 is a front perspective view depicting the filter retainer clip of FIG. 3 holding a V-type filter element in a filter holding frame.

FIG. 7 is a side perspective view depicting the filter retainer clip of FIG. 6.

FIG. 8 is a front perspective view depicting the filter retainer clip of FIG. 3 holding a pleated filter element placed over the V-type filter of FIG. 6.

FIG. 9 is a side perspective view depicting the filter retainer clip of FIG. 8.

FIG. 10 is a side perspective view depicting the filter retainer clip of FIG. 3 holding a spun-glass filter element placed over the V-type filter of FIG. 6.

FIG. 11 is a diagram depicting front elevation views of an alternate embodiment of the filter retainer clip of FIG. 3.

FIG. 12 is a diagram depicting bottom perspective views of the alternate embodiment of the filter retainer clip of FIG. 11.

FIG. 13 is a diagram depicting top perspective views of the alternate embodiment of the filter retainer clip of FIG. 11.

FIG. 14 is a bottom perspective exploded view depicting a third embodiment of the filter retainer clip of FIG. 3.

FIG. 15 is a side elevation exploded view depicting the filter retainer clip of FIG. 14.

FIG. 16 is a front elevation view depicting the filter retainer clip of FIG. 14.

FIG. 17 is a side elevation cut-away view depicting the filter retainer clip of FIG. 14 along section lines A-A.

FIG. 18 is a front elevation close-up view depicting Detail B of the filter retainer clip of FIG. 16.

FIG. 19 is a side elevation close-up view depicting Detail C of the filter retainer clip of FIG. 17.

FIG. 20 is a perspective view depicting the top plate of the filter retainer clip of FIG. 14.

FIG. 21 is front elevation view depicting the top plate of FIG. 20.

FIG. 22 is a top plan cut-away view depicting the top plate of FIG. 21 along section lines A-A.

### DETAILED DESCRIPTION OF EMBODIMENTS:

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments but is not necessarily included. Thus, the present technology can include a variety of combinations and/or integrations of the embodiments described herein.

The presently disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently disclosed subject matter.

Unless defined otherwise, all technical and scientific terms used herein have the same meaning as commonly understood by one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in this application, including the claims.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about”, when referring to a value or to an amount of mass, weight, time, volume, concentration or percentage is meant to encompass variations of in some embodiments +/−50%, in some embodiments +/−40%, in some embodiments +/−30%, in some embodiments +/−20%, in some embodiments +/−10%, in some embodiments +/−5%, in some embodiments +/−1%, in some embodiments +/−0.5%, and in some embodiments +/−0.1% from the specified amount, as such variations are appropriate to perform the disclosed method.

Alternatively, the terms “about” or “approximately” can mean within an acceptable error range for the particular value as determined by one of ordinary skill in the art, which will depend in part on how the value is measured or determined, i.e., the limitations of the measurement system. For example, “about” can mean within 3, or more than 3, standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Unless otherwise indicated, all numbers expressing quantities, properties, and so forth used in the specification and claims are to be understood as being modified in all instances by the term “about”. And so, the numerical parameters set forth in this specification and claims are approximations that can vary depending upon the desired properties sought to be obtained by the presently disclosed subject matter.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

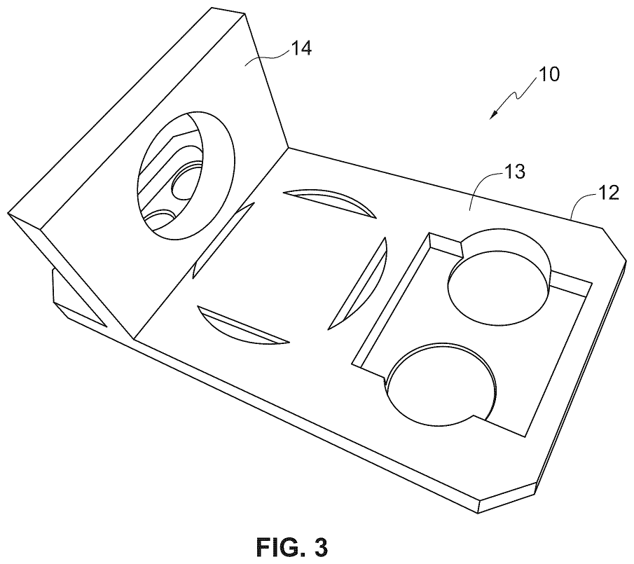

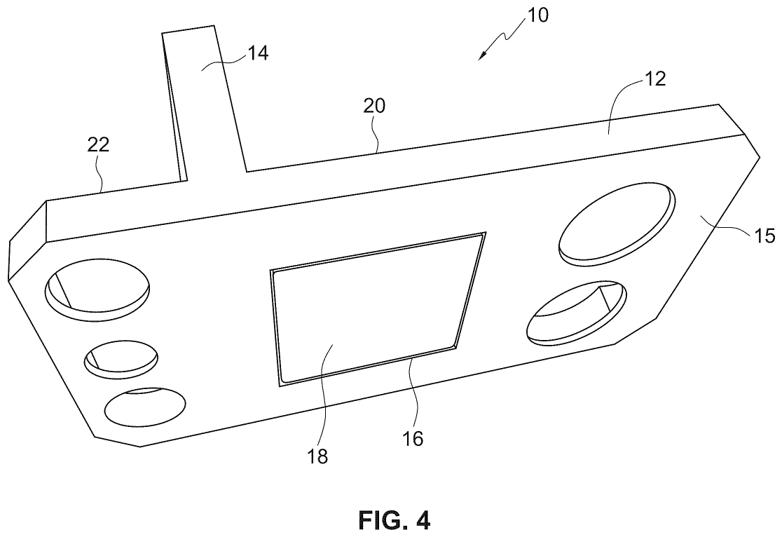

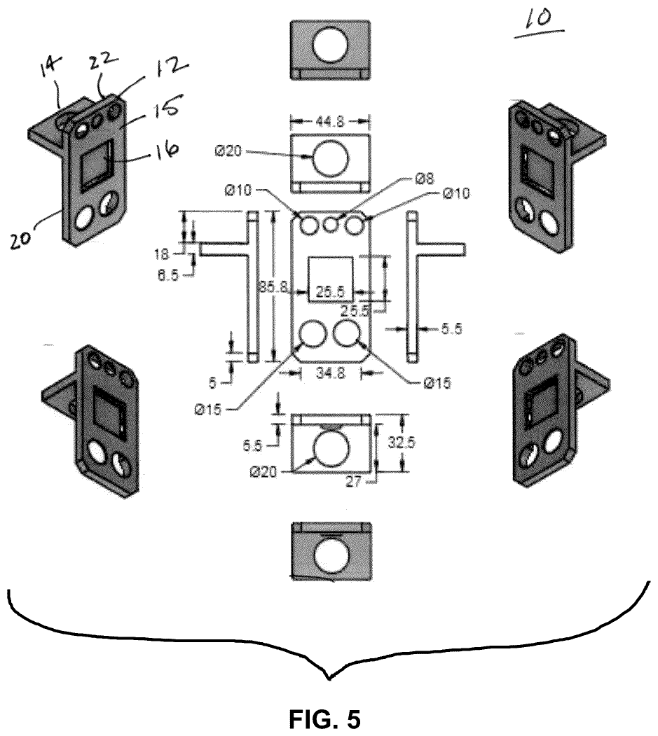

Referring to FIGS. 3 to 5, one embodiment of filter retainer clip 10 is shown. In some embodiments, filter retainer clip 10 can comprise of base 12 and grip/stop 14 disposed substantially orthogonal on top surface 13 thereof. In some embodiments, grip/stop 14 can be positioned on base 12 at a location wherein retainer clip 10 can comprise legs 20 and 22. In some embodiments, leg 20 can be longer than leg 22. In some embodiments, bottom surface 15 of base 12 can comprise recess 16 configured to receive magnet 18. In some embodiments, the depth of recess 16 can equal that of the thickness of magnet 18 such the combination of bottom surface 15 and magnet 18 forms a uniformly flat surface. In some embodiments, magnet can be held in place in recess 16 by a friction fit or by a suitable adhesive as well known to those skilled in the art. In some embodiments, magnet 18 can be rectangular in shape with recess 16 similarly shaped to receive magnet 18 although other shapes, such as circular or elliptical, or any other suitable shape as well known to those skilled in the art.

In some embodiments, filter retainer clip 10 can be comprised of high-density plastic, non-ferrous metal, or other suitable non-magnetic materials as well known to those skilled in the art such that filter retainer clip 10 only magnetically attaches to filter holder frame B by operation of magnet 18. In some embodiments, magnet 18 can comprise a rare earth magnet. In the illustrated embodiment, magnet 18 can comprise a rare earth magnet having dimensions of 1″×1″×⅛″ and having a pull strength of 28 pounds. In other embodiments, magnet 18 can comprise a rare earth magnet having dimensions of 1″×1″×¼″ and having a pull strength of 36 pounds. In other embodiments, the dimensions and pull strength of magnet 18 can be adjusted upwards or downwards as required for the particular application of filter retainer clip 10.

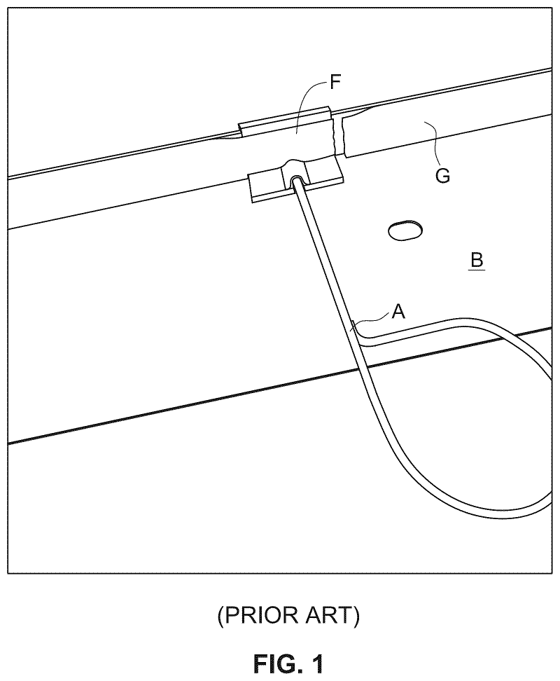

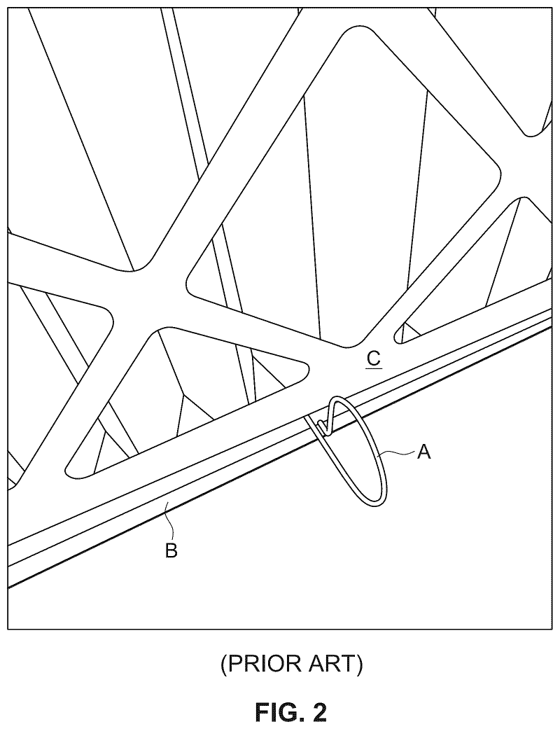

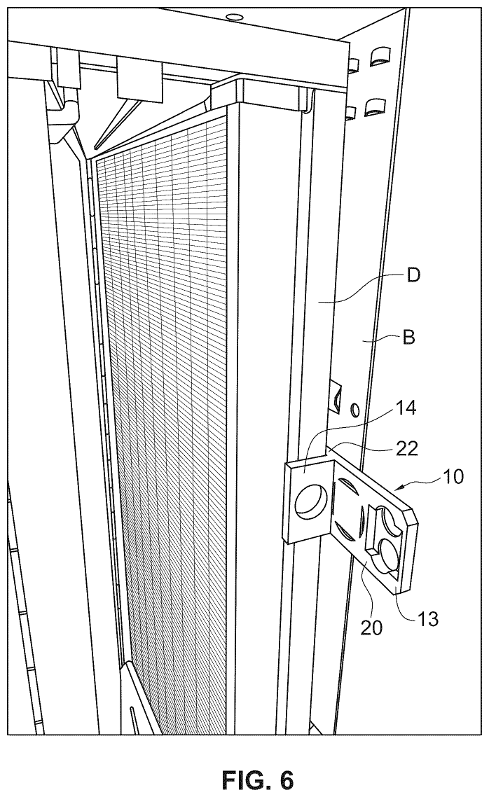

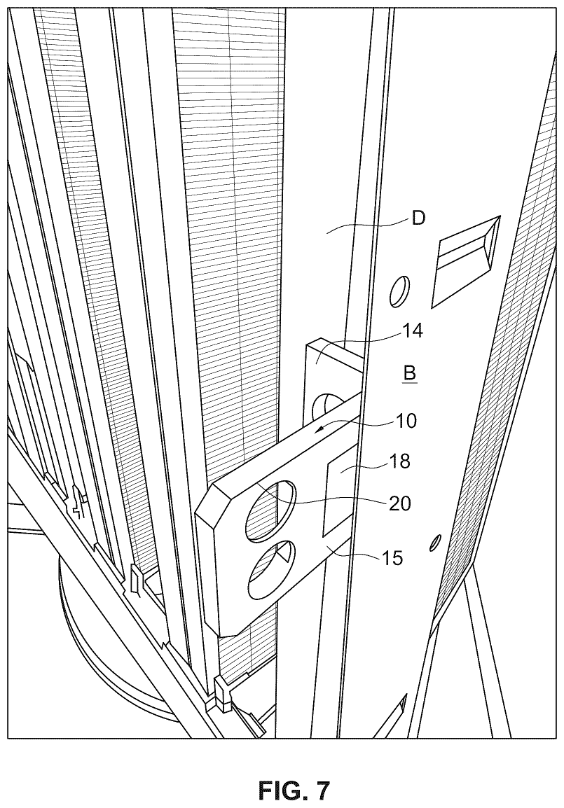

Referring to FIGS. 6 and 7, one embodiment of filter retainer clip 10 is shown holding V-type filter element D in filter holder frame B. Leg 22 of filter retainer clip 10 is shown inserted between V-type filter element D and filter holder frame B. In some embodiments, magnet 18 magnetically attaches to filter holder frame B and grip/stop 14 presses against V-type filter element D to seat it against seating surface G (as shown in FIG. 1).

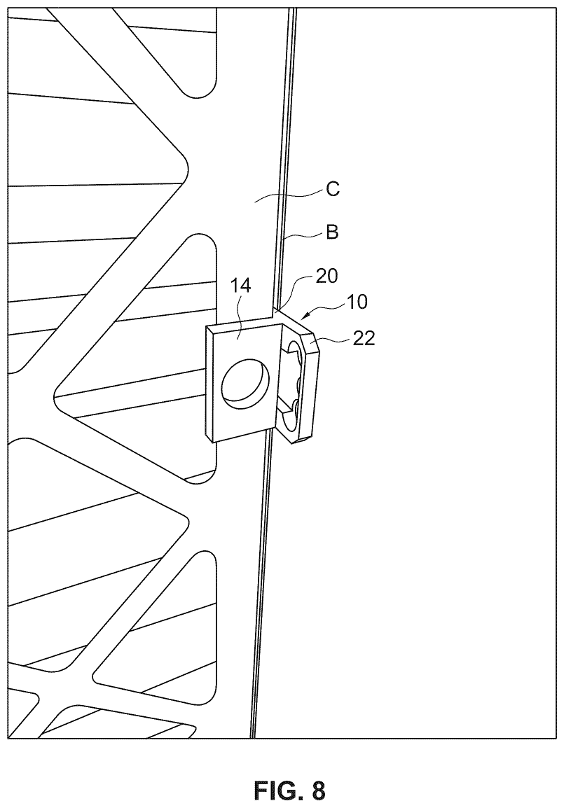

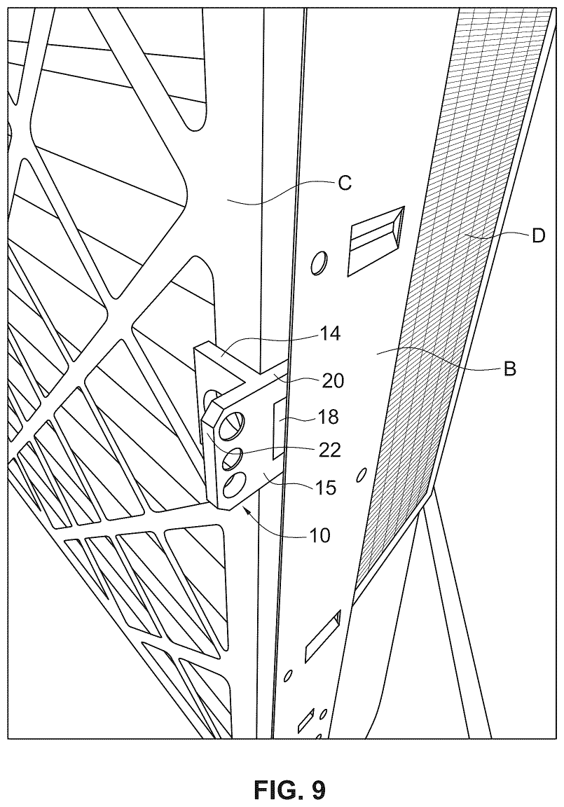

In some embodiments, additional filter elements can be stacked in front of V-type filter element D. Referring to FIGS. 8 and 9, pleated filter element C can be placed in front of V-type filter element D and held in place with filter retainer clip 10 wherein leg 20 is inserted between pleated filter element C and filter holder frame B wherein magnet 18 magnetically attaches to filter holder frame B to hold filter retainer clip 10 in place thereby allowing grip/stop 14 to hold pleated filter element C and V-type filter element D in filter holder frame B.

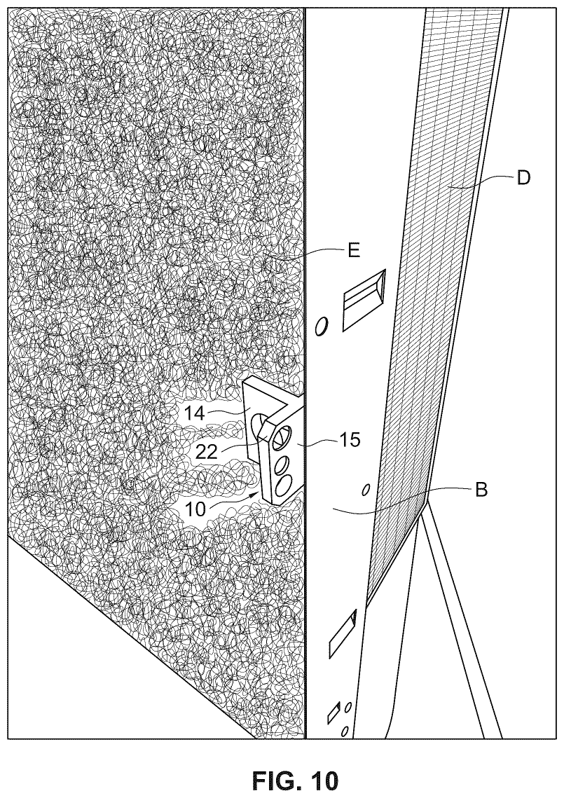

In other embodiments, spun-glass filter element E can be stacked in front of V-type filter element D, as shown in FIG. 10. Similar to what is shown in FIGS. 8 and 9, spun-glass filter element C En be placed in front of V-type filter element D and held in place with filter retainer clip 10 wherein leg 20 is inserted between spun-glass filter element C and filter holder frame B wherein magnet 18 magnetically attaches to filter holder frame B to hold filter retainer clip 10 in place thereby allowing grip/stop 14 to hold spun-glass filter element E and V-type filter element D in filter holder frame B.

Referring to FIGS. 11 to 13, an alternate embodiment of filter retainer clip 10 is shown. In this embodiment, recess 16 can be disposed on top surface 13 for receiving magnet 18 in this embodiment to fit within recess 16. In some embodiments, opening 24 can be disposed through base 12, wherein recess 16 can form lip or ledge 17 for magnet 18 to be placed thereon. Magnet 18 can be retained within recess 16 by a friction fit or it can be retained by using an adhesive to glue magnet 18 therein.

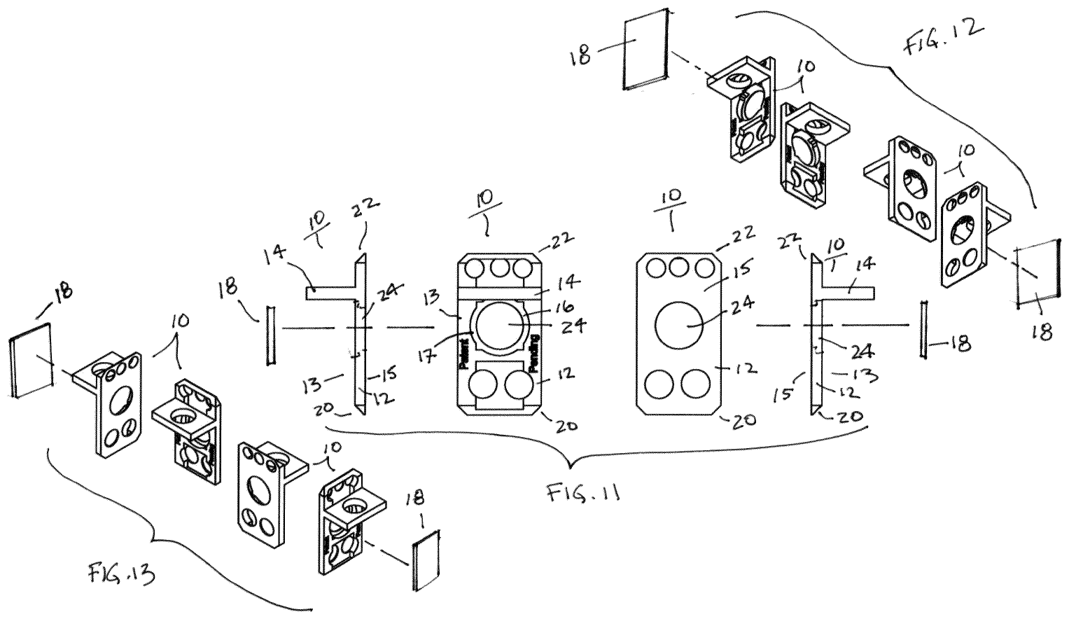

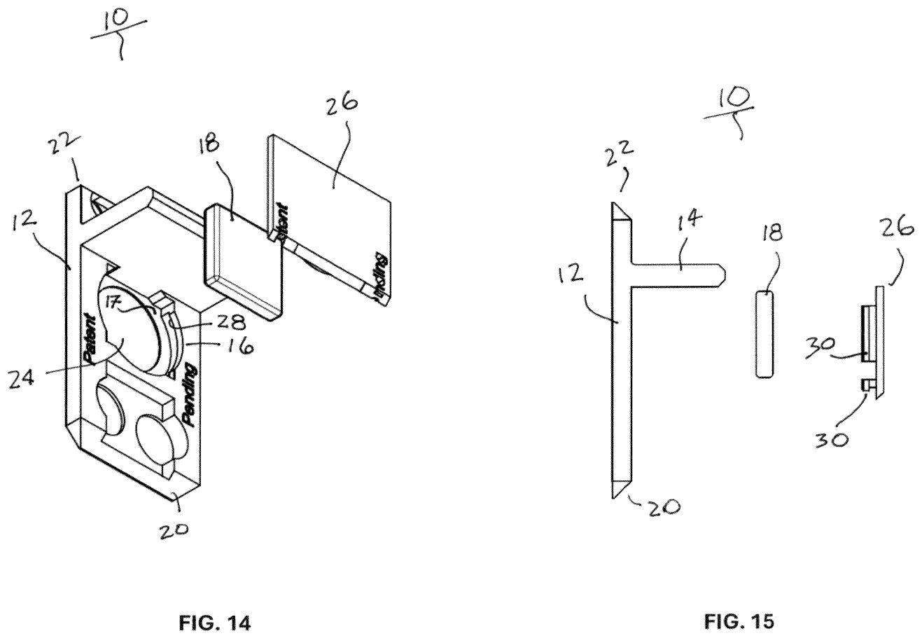

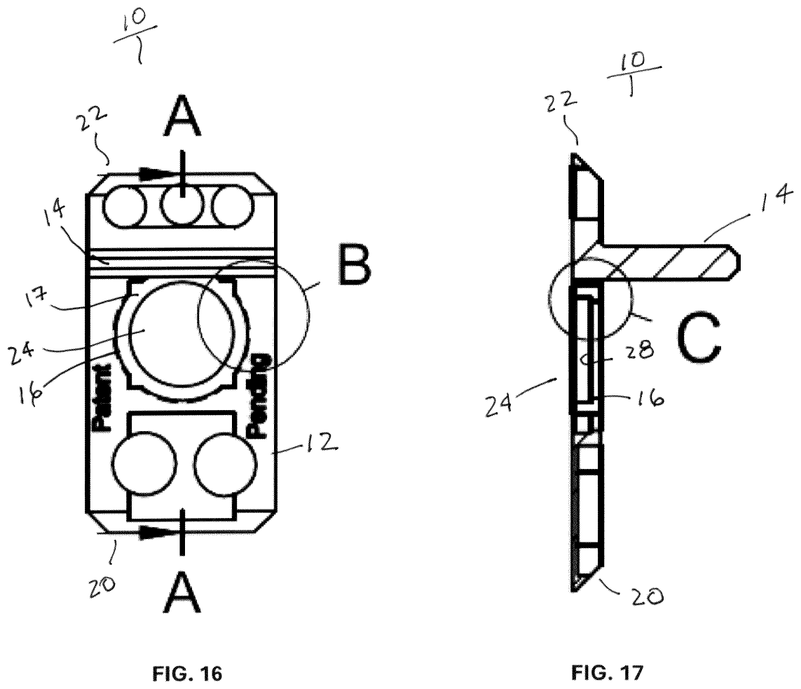

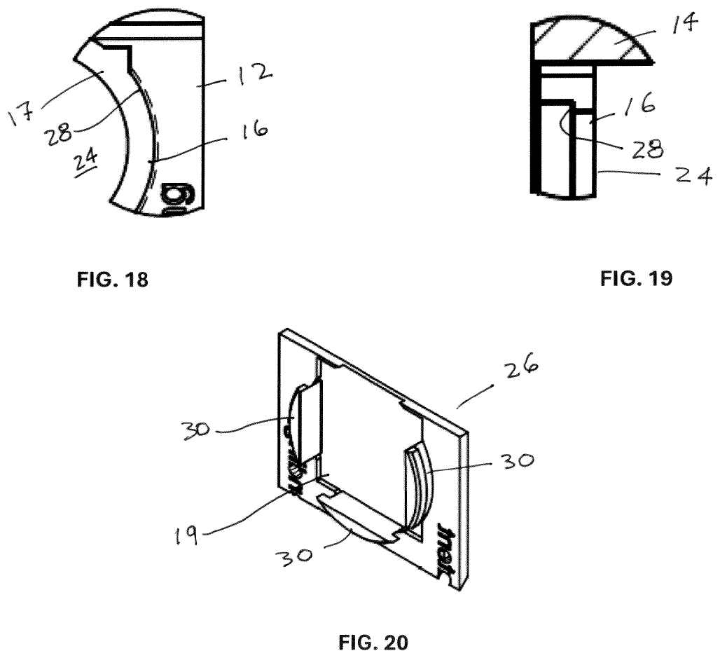

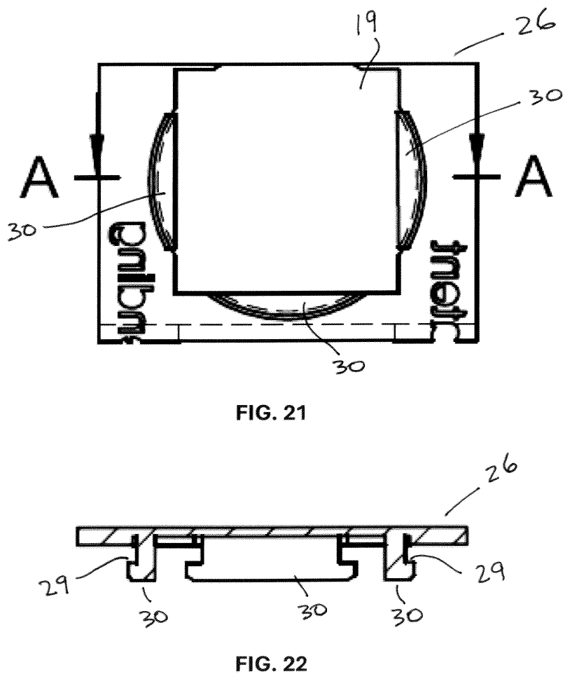

Referring to FIGS. 14 to 22, a third embodiment of filter retainer clip 10 is shown. In some embodiments, filter retainer clip 10 can comprise of magnet 18 disposed within recess 16 of base 12, which can then be held in place by top plate 26. In some embodiments, top plate 26 can comprise one or more catches 30, each having a hook 29, disposed about recess 19, which can provide an opening for receiving magnet 18. In some embodiments, recess 16 disposed on base 12 can comprise channel 28 disposed at least partially about a circumference of recess 16, wherein channel 28 can be configured to receive hook 29 of catches 30 when catches 30 are inserted into recess 16 to attach top plate 26 to base 12, thereby sandwiching magnet 18 between base 12 and top plate 26 to retain magnet 18 within filter retainer clip 10.

Although a few embodiments have been shown and described herein, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. An apparatus for retaining a filter element in a filter holder frame, the apparatus comprising:
a) a base comprising a top surface and a bottom surface;
b) a grip/stop disposed substantially orthogonal on a top surface of the base forming a first leg on one side of the grip/stop and forming a second leg on another side of the grip/stop; and
c) a magnet disposed on the top surface or on the bottom surface.

2. The apparatus as set forth in claim 1, wherein the first leg is longer than the second leg.

3. The apparatus as set forth in claim 1, wherein the bottom surface comprises a recess for receiving the magnet.

4. The apparatus as set forth in claim 3, further comprising adhesive for holding the magnet in the recess.

5. The apparatus as set forth in claim 3, wherein the combination of the magnet and the bottom surface form a uniformly flat surface.

6. The apparatus as set forth in claim 1, wherein the top surface comprises a recess for receiving the magnet.

7. The apparatus as set forth in claim 6, further comprising adhesive for holding the magnet in the recess.

8. The apparatus as set forth in claim 1, wherein the apparatus is comprised of high-density plastic.

9. The apparatus as set forth in claim 1, wherein the apparatus is comprised of non-ferrous metal.

10. The apparatus as set forth in claim 6, further comprising a channel disposed at least partially about a circumference of the recess.

11. The apparatus as set forth in claim 10, further comprising a top plate for sandwiching the magnet between the top plate and the base, the top plate comprising at least one catch having a hook thereon, the hook configured for inserting into the channel to attach the top plate to the base.

12. The apparatus as set forth in claim 11, wherein the top plate comprises a second recess for receiving the magnet.
